(19) United States
(12) Patent Application Publication
(10) Pub. No.: US 2026/0204080 A1
(43) Pub. Date: Jul. 16, 2026

(54) METHOD FOR MEASURING DISTANCE TO OBJECT AND ROBOT FOR IMPLEMENTING SAME

(71) Applicant: LG ELECTRONICS INC., Seoul (KR)

(72) Inventors: Soonhong JUNG, Seoul (KR); Myounghun KEUM, Seoul (KR); Minkyu CHOI, Seoul (KR); Minje PARK, Seoul (KR)

(73) Assignee: LG ELECTRONICS INC., Seoul (KR)

(21) Appl. No.: 19/137,044

(22) PCT Filed: Dec. 29, 2022
(86) PCT No.: PCT/KR2022/021607

§ 371 Date: Jun. 9, 2025

(51) Int. Cl. G06V 20/56; G06T 7/11; G06T 7/50

(52) U.S. Cl. CPC G06V 20/588; G06T 7/11; G06T 7/50; G06T 2207/10028; G06T 2207/30252

(57) ABSTRACT

The present disclosure relates to a method for measuring a distance to an object, that can accurately measure a separation distance or depth to a relatively distant object or obstacle even by means of a low-cost depth sensor with a relatively narrow depth measurement range, and to a robot that can implement same. The present disclosure may provide a method, in a robot, for measuring a distance to an object, comprising the steps of: acquiring a camera image; if a driving path surface in the camera image is determined to be a plane, obtaining homography between the camera image and the plane; and calculating the depth of an object recognized in the camera image on the basis of the obtained homography.

### CROSS-REFERENCE TO RELATED APPLICATION(S)

This application is the National Stage filing under 35 U.S.C. 371 of International Application No. PCT/KR2022/021607, filed on Dec. 29, 2022, the contents of which are all incorporated by reference herein in its entirety.

### TECHNICAL FIELD

The present disclosure relates to a method of measuring a distance to a distant object or an object by a mobile object such as a robot including a low-specification depth sensor, and a robot or mobile object implementing the method. The mobile object may include a vehicle.

### BACKGROUND

The robot has been developed for industry and has been responsible for a part of factory automation. Recently, a robot-applied field has been further enlarged, so that a medical robot, an aerospace robot, and the like are developed, and a home robot that can be used in a general home is also being made. Among these robots, there is a robot capable of self-driving.

If such a robot moves along a target path, when an object or obstacle appears in the vicinity, a target path may be modified to avoid colliding with the object or the obstacle and the robot may move toward a target position along another appropriate movement path. Much research has been conducted on an algorithm to find the optimal other suitable movement path and movement speed to reach the target position as quickly as possible without colliding with surrounding objects or obstacles.

To this end, it is important for the robot to accurately determine a distance or depth to surrounding objects or obstacles that are relatively far away from the robot. To this end, this requires an expensive depth sensor to measure the distance or depth to a distant surrounding object or obstacle. However, if an expensive depth sensor is installed on the robot to this end, the production cost of the robot may inevitably increase, which is a problem.

### DISCLOSURE

### Technical Problem

An object of the present disclosure is to provide a method of measuring a distance to an object, and a robot and mobile object for implementing the method, which accurately measure a distance or depth to a relatively distant object or obstacle even using a low-cost depth sensor with a relatively narrow depth measurement range.

### Technical Solution

To achieve the object, the present disclosure provides a method of measuring a distance to an object by a robot, including obtaining a camera image, based on a driving path ground in the camera image being to be a plane, obtaining homography between the camera image and the plane, and calculating a depth of an object recognized in the camera image based on the obtained homography.

The method may further include recognizing the driving path ground of the robot from the camera image.

The recognizing of the driving path ground may be performed by performing scene segmentation.

The method may further include measuring a depth for a plurality of sampling points on the recognized driving path ground, wherein, whether the driving path ground is planar may be determined based on the measured depth.

Whether the driving path ground is planar may be determined based on a RANdom sample consensus (RANSAC) algorithm.

The method may further include performing flattening of the driving path ground of the camera image based on that the driving path ground is determined to be non-planar.

The method may further include generating a local map of the robot based on the depth of the driving path ground recognized as the object in the camera image.

The local map may be generated by inverse perspective mapping from the camera image.

A virtual straight-line distance between the robot and the object according to the flattening may be reflected in the local map.

An inlier from among points on the driving path ground of the camera image may correspond to a map point of the local map, and an outlier from among points on the driving path ground may be disregarded in the local map.

To achieve the object, the present disclosure provides a robot including a camera configured to obtain a camera image, a depth sensor configured to sense a depth of an object; and a controller configured to perform control to, based on a driving path ground in the camera image being to be a plane, obtain homography between the camera image and the plane, and calculate the depth of the object recognized in the camera image based on the obtained homography.

The controller may be configured to recognize a driving path ground of the robot from the camera image.

The controller may be configured to recognize the driving path ground by performing scene segmentation.

The controller may be configured to measure a depth for a plurality of sampling points on the recognized driving path ground and determine whether the driving path ground is planar based on the measured depth.

The controller may be configured to perform flattening of the driving path ground of the camera image based on that the driving path ground is determined to be non-planar.

The controller may be configured to generate a local map of the robot based on a depth of the driving path ground as the object in the camera image.

### Advantageous Effects

Effects of a method of measuring a distance to an object and a robot implementing the method according to the present disclosure are as follows.

According to at least one of the embodiments of the present disclosure, there is an advantage in that even if a robot includes a low-cost depth sensor with a relatively narrow depth measurement range, the robot may accurately measure the distance or depth to an object or obstacle at a relatively long distance.

### BRIEF DESCRIPTION OF THE DRAWINGS

FIG. 1 is a block diagram illustrating components constituting a robot according to an embodiment of the present disclosure.

FIG. 2 is a flowchart of a method of measuring a distance to an object according to an embodiment of the present disclosure.

FIG. 3 shows an example of homography.

FIGS. 4 and 5 illustrate an example of recognizing a driving path according to one embodiment of the present disclosure.

FIG. 6 is a flowchart of a method of measuring a distance to an object according to an embodiment of the present disclosure.

FIG. 7 illustrates an example of IPM that may be used in an embodiment of the present disclosure.

FIG. 8 illustrates an example of a local map for a robot generated according to an embodiment of the present disclosure.

FIG. 9 is a flowchart of a method of measuring a distance to an object according to an embodiment of the present disclosure.

FIGS. 10 to 12 illustrate an example of flattening of a driving path surface for a method of measuring a distance to an object, according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It should be noted that the following examples of the present disclosure are only intended to illustrate the present disclosure and do not limit or restrict the scope of the present disclosure. Concepts that may be easily inferred by an expert in the technical field to which the present disclosure pertains from the detailed description and examples of the present disclosure are interpreted as falling within the scope of the present disclosure.

The above detailed description should not be construed as limiting in any aspect and should be considered illustrative. The scope of the present disclosure should be determined by a reasonable interpretation of the appended claims, and all changes within the equivalent scope of the present disclosure are intended to be included within the scope of the present disclosure.

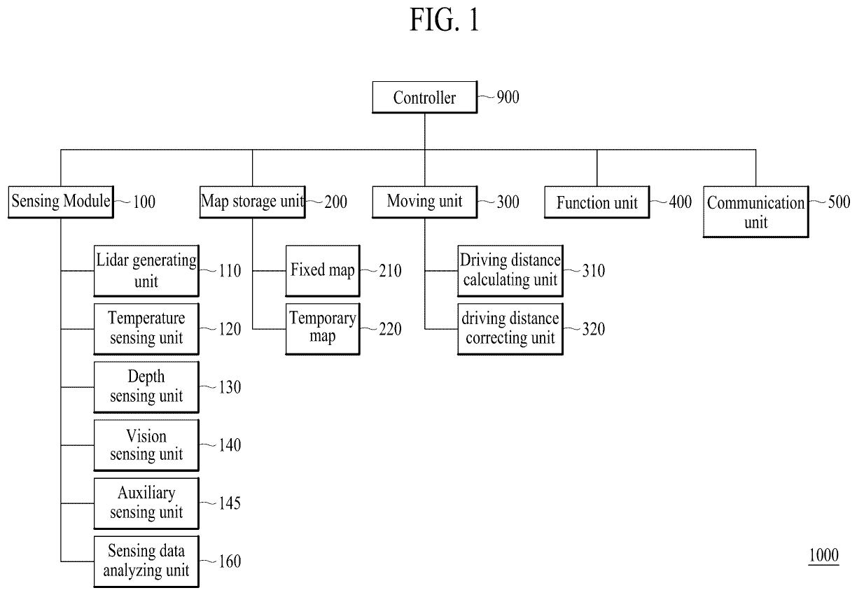

Components constituting a robot according to an embodiment of the present disclosure will be described with reference to FIG. 1. FIG. 1 is a block diagram illustrating components constituting a robot according to an embodiment of the present disclosure.

A robot 1000 may include a sensing module 100 for sensing a moving object or a fixed object disposed outside, a map storage unit 200 for storing various types of maps, a moving unit 300 for controlling the movement of the robot, a function unit 400 for performing a prescribed function of the robot, a communication unit 500 for transmitting and receiving information about a map or a moving object, a fixed object, or an external changing situation with another robot or a server, and a controller 900 for controlling each of these components.

FIG. 1 hierarchically configures the components of a robot, which shows the components of the robot logically. A physical configuration thereof may be different. That is, a multitude of logical components may be included in one physical component, or a plurality of physical components may implement one logical component.

The sensing module 100 senses external objects such as an obstacle and provides sensed information to the controller 900. According to an embodiment, the sensing module 100 may include a lidar sensing unit 110 that calculates a material and a distance of external objects such as a wall, glass, a metallic door and the like at a current position of the robot as an intensity and reflected time (speed) of a signal. In addition, the sensing module 100 may include a temperature sensing unit 120 that calculates temperature information of objects disposed within a predetermined distance from the robot 1000. An embodiment of the temperature sensing unit 120 includes an infrared sensor that senses a temperature of a thing disposed within a predetermined distance from the robot 1000, particularly, body temperatures of people. When the temperature sensing unit 120 is configured with an infrared array sensor, a temperature of an object may be sensed without contact. When the infrared sensor or the infrared array sensor configures the temperature sensing unit 120, main information for checking whether a moving object is a person may be provided.

In addition, the sensing module 100 may further include a depth sensing unit 130 that calculates depth information between the robot and an external object and a vision sensing unit 140 in addition to the sensing units described above.

The depth sensing unit 130 may include a depth camera. The depth sensing unit 130 may determine a distance between the robot and the external object, and in particular, may be coupled to the lidar sensing unit 110 to increase the sensing accuracy of the distance between the external object and the robot.

The vision sensing unit 140 may include a camera. The vision sensing unit 140 may capture images of objects around the robot. In particular, the robot may identify whether an external object is a moving object by distinguishing between an image in which there is no change like a fixed object and an image in which a moving object is disposed.

In addition, a multitude of auxiliary sensing units 145 such as a heat sensing unit, a ultrasonic sensing unit, and the like may be disposed. These auxiliary sensing units provide auxiliary sensing information necessary to generate a map or sense an external object. In addition, the auxiliary sensing units also provide information by sensing an object disposed outside when the robot travels.

The sensing data analyzing unit 160 analyzes the information sensed by a multitude of the sensing units and transmits the analyzed information to the controller 900. For example, when an object disposed outside is sensed by a multitude of the sensing units, each of the sensing units may provide information about the characteristics and distance of the corresponding object. The sensing data analyzing unit 160 may perform calculation by combining values of the informations and transmit the calculation result to the controller 900.

The map storage unit 200 stores information of objects disposed in a space in which the robot moves. The map storage unit 200 may include a fixed map 210 that stores information about fixed objects, which have no variation or are disposed in a manner of being fixed, among objects disposed in an entire space in which the robot moves. A single fixed map 210 may be essentially included depending on a space. Since only objects having the lowest change in the corresponding space are disposed in the fixed map 210, it may sense more objects than objects than those indicated by the map 210 when the robot moves in the corresponding space.

The fixed map 210 essentially stores position information of the fixed objects, and may additionally include characteristics of the fixed objects, for example, material information, color information, other height information, etc. When a variation item occurs in the fixed objects, these additional informations facilitate the robot to check the variation item.

In addition, the robot may generate a temporary map 220 by sensing the surroundings in the process of moving, and compare the temporary map 220 with the fixed map 210 for the entire space stored in the past. As a result of the comparison, the robot may confirm a current position.

The moving unit 300 is a means for moving the robot 1000, such as a wheel, and moves the robot 1000 under the control of the controller 900. In doing so, the controller 900 may check a current position of the robot 1000 in the area stored in the map storage unit 200 and provide a moving signal to the moving unit 300. The controller 900 may generate a path in real time or generate a path in a movement process by using various informations stored in the map storage unit 200.

The moving unit 300 may include a driving distance calculating unit 310 and a driving distance correcting unit 320. The driving distance calculating unit 310 may provide information on the distance traveled by the moving unit 300. According to an embodiment, the accumulated distance moved by the robot 1000 starting at a specific point may be provided. Alternatively, an accumulated distance for the robot 1000 to move linearly after rotating at a specific point may be provided. Alternatively, an accumulated distance for the robot 1000 to move from a specific timing point may be provided.

In addition, according to an embodiment of the present disclosure, the driving distance calculating unit 310 may provide information on a moving distance within a predetermined unit as well as an accumulated distance. The driving distance calculating unit 310 may calculate various distances according to the characteristics of the moving unit 300. When the moving unit 300 is a wheel, the driving distance calculating unit 310 may calculate a driving distance by counting the number of rotations of the wheel.

When the distance calculated by the driving distance calculating unit 310 is different from the distance information actually calculated by the sensing module 100 of the robot 1000, the driving distance correcting unit 320 corrects the distance information calculated by the driving distance calculating unit 310. In addition, when an error occurs in a manner of being accumulated in the driving distance calculating unit 310, the controller 900 or the moving unit 300 may be informed to change the driving distance calculation logic of the driving distance calculating unit 310.

The function unit 400 means to provide a specialized function of the robot. For example, in case of a cleaning robot, the function unit 400 includes components required for cleaning. In case of a guidance robot, the function unit 400 includes components required for guidance. In case of a security robot, the function unit 400 includes components required for security. The function unit 400 may include various components according to functions provided by the robot, by which the present disclosure is non-limited.

The controller 900 of the robot 1000 may generate or update a map of the map storage unit 200. In addition, the controller 900 may identify whether an object is a moving object or a fixed object by identifying information of the object provided by the sensing module 100 during a driving process, thereby controlling the driving of the robot 1000.

In summary, when the sensing module 100 senses an object disposed outside, the controller 900 of the robot 1000 may identify a moving object among objects sensed based on the characteristic information of the sensed objects, thereby setting a current position of the robot based on the information sensed by the sensing module as a fixed object except the moving object.

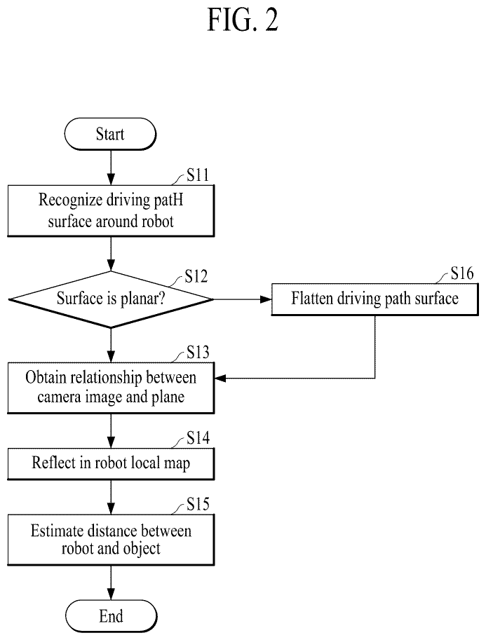

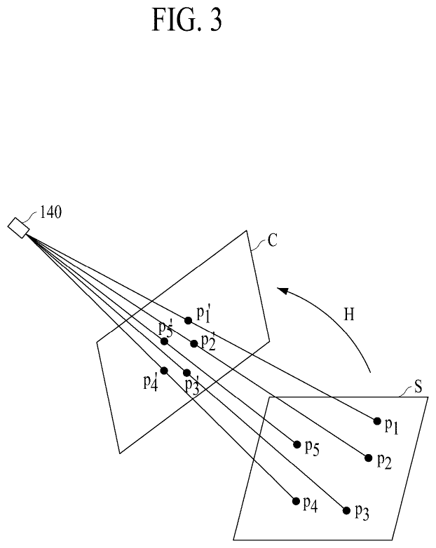

Hereinafter, with reference to FIGS. 2 and 3, a method of measuring a method of measuring a distance to an object by a robot according to an embodiment of the present disclosure will be described. FIG. 2 is a flowchart of a method of measuring a distance to an object according to an embodiment of the present disclosure. FIG. 3 shows an example of homography.

The camera 140 of the robot 1000 may be located at an appropriate location on the robot 1000 to face the outside of the robot 1000 to obtain an external image of the robot 1000. For example, the camera 140 may be located on a front surface of the robot 1000 to obtain an image of a front side of the robot 1000. The camera 140 may be for obtaining two-dimensional (2D) moving images or still images. Hereinafter, the external image captured by the camera 140 will be referred to as a camera image or a 2D camera image. The camera image may be obtained in real time and provided to the controller 900.

The depth sensor 130 of the robot 1000 may be positioned at an appropriate location on the robot 1000 to face the outside of the robot 1000 to obtain a depth (or separation distance) of an object surrounding the robot 1000. The surrounding object may be an obstacle or the ground surrounding in which the robot 1000 is located. For example, the depth sensor 130 may be located on the front surface of the robot 1000 to obtain a depth of an object at the front side of the robot 1000. Depth information of surrounding objects of the robot 1000 may be provided to the controller 900. When the depth sensor 130 has low specifications, the depth sensor 130 may only measure a depth of an object that is relatively close to the robot 1000.

The controller 900 may recognize a surface (or ground) of a driving path around the robot 1000 from the depth information [S11]. The surface may be recognized in real time. If the depth sensor 130 has low specifications, the controller may only recognize the surface of the driving path within a relatively short distance from the robot 1000.

Then, the controller 900 may determine whether the surface of the driving path is planar [S12]. The above determination of whether the surface of the driving path is planar may be performed, for example, through a random sample consensus (RANSAC) algorithm. If plane equation coefficients (a, b, and c) that satisfy a plane equation (e.g., z=ax+by+c) within a predetermined error range are obtained by the RANSAC algorithm for the depth of the surface of the driving path (or a plurality of sampling points on the surface) of the driving path, the surface of the driving path may be determined to be a plane. If the plane equation coefficients are obtained, a surface plane of the driving path may be defined by the plane equation coefficients.

When the surface of the driving path is determined to be planar, the controller 900 may obtain a spatial relationship between the camera image and the surface [S13]. The spatial relationship may be defined by homography. The homography may be defined in real time.

The homography may be defined as a transformation relationship H that is consistently established when a floor plane S is projected onto another plane C such as a camera image and a plurality of points p1, p2, p3, p5, and p5 on the floor plane S correspond to a plurality of points pl′, p2′, p3′, p5′, and p5′ of the camera image plane C, as illustrated in FIG. 3.

The controller 900 may calculate a depth of an object recognized in the camera image C on the basis of the homography.

The controller 900 may reflect the depth of the object in a local map of the robot [S14]. The controller 900 may estimate a separation distance of the object on the basis of the calculated depth of the object [S15].

Operations S14 and S15 above may be performed simultaneously or in reverse order.

If the surface of the driving path is determined to be non-planar in operation S12, the controller 900 may perform a flattening process of the surface of the driving path [S16]. The flattening process will be explained below.

Then, the controller 900 may obtain the spatial relationship between the camera image and the flattened surface [S13].

Operations after operation S13 are as described above.

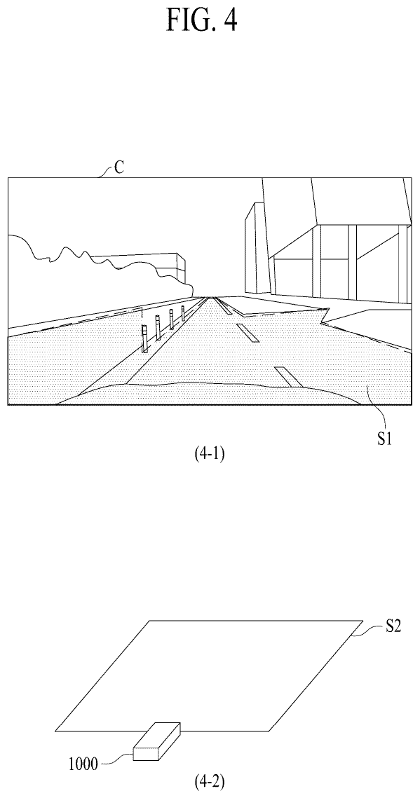

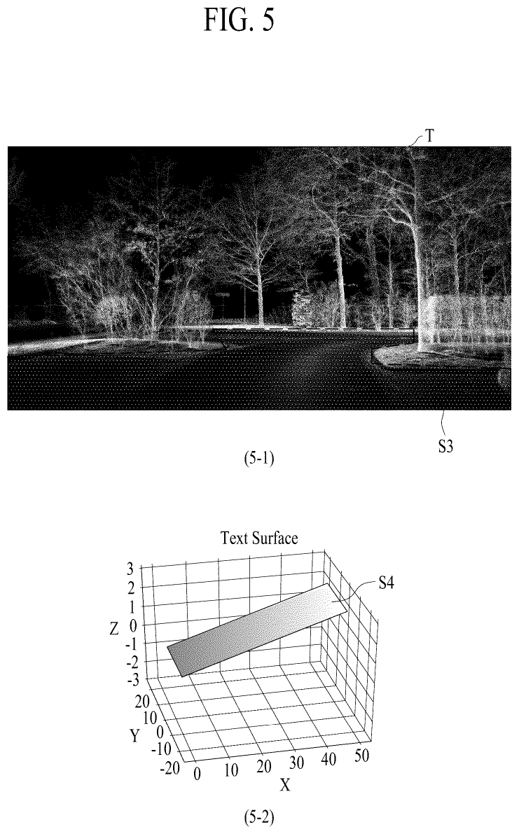

Hereinafter, with reference to FIGS. 4 and 5, recognition of the surface of the driving path will be described. FIGS. 4 and 5 illustrate an example of recognizing a driving path according to one embodiment of the present disclosure.

When the camera image C is obtained, the controller 900 may attempt to obtain depth information for all objects in the camera image through the depth sensor 130. That is, the controller 900 may obtain depth information for all objects within a range of the performance of the depth sensor 130 from among all objects in the camera image.

However, in this case, depth calculation may also be performed on an object other than a surface of a driving path (e.g., tree or building), which may be unnecessary.

Therefore, the controller 900 may recognize a driving path surface S1 by performing scene segmentation on the camera image C, as shown in (4-1) of FIG. 4. The scene segmentation may be performed using artificial intelligence technology such as computer vision technology or machine learning algorithms.

To explain artificial intelligence in more detail, artificial intelligence refers to a field that studies artificial intelligence or a methodology for generating the same, and machine learning refers to a field that defines various problems in the field of artificial intelligence and studies a methodology for resolving the problems. Machine learning is also defined as an algorithm that improves the performance on a task through continuous experience with the task.

An artificial neural network (ANN) is a model used in machine learning and may refer to a model with capabilities for resolving problems, which are configured with artificial neurons (nodes) that form a network by combining synapses. The ANN may be defined by a connection pattern between neurons in different layers, a learning process that updates a model parameter, and an activation function that generates an output value.

The ANN may include an input layer, an output layer, and optionally one or more hidden layers. Each layer includes one or more neurons, and the ANN may include a synapse connecting neurons. In the ANN, each neuron may output a function value of an activation function for input signals, weights, and biases received through synapses.

The model parameter refers to a parameter determined through learning and includes a weight of synaptic connection and bias of neurons. A hyperparameter refers to a parameter that needs to be set before learning in a machine learning algorithm and includes a learning rate, a number of iterations, a mini-batch size, and an initialization function.

The purpose of learning the ANN may be seen as determining a model parameter that minimize a loss function. The loss function may be used as an indicator to determine an optimal model parameter during a learning process of the ANN.

Machine learning may be classified into supervised learning, unsupervised learning, and reinforcement learning depending on a learning method.

The supervised learning may refer to a method of training an artificial neural network in a state in which a label for training data is given, and the label may refer to a correct answer (or result value) that the ANN needs to infer when training data is input to the ANN. The unsupervised learning may refer to a method of training the ANN in a state in which a label for learning data is not given. The reinforcement learning may refer to a learning method that teaches an agent defined in a certain environment to select an action or action sequence that maximizes a cumulative reward in each state.

Machine learning implemented with a deep neural network (DNN) that includes a plurality of hidden layers in the ANN is also called deep learning, and deep learning is a part of machine learning. Hereinafter, machine learning is used to mean including deep learning.

An object detection model using machine learning includes a single-step you only look once (YOLO) model and two-step faster regions with convolution neural network (R-CNN) model.

The YOLO model is a model that may predict an object within an image and the position of the corresponding object by looking at the image only once.

The YOLO model divides an original image into grids of the same size. For each grid, the number of bounding boxes specified in a predefined shape centered around the center of the grid is predicted, and the reliability is calculated based thereon.

Then, whether the image includes an object or only a background, and the position with high object reliability is selected such that an object category may be identified.

The faster R-CNN model is a model that may detect an object faster than the RCNN model and the fast RCNN model.

The faster R-CNN model is described in detail.

First, a feature map is extracted from the image through a convolution neural network (CNN) model. Based on the extracted feature map, a plurality of regions of interest (RoI) are extracted. RoI pooling is performed for each RoI.

The RoI pooling is a process of setting a grid to a predetermined size of H×W for a feature map onto which the RoI is projected, extracting the largest value for each cell included in each grid, and extracting the feature map with a size of H×W.

A feature vector may be extracted from the feature map having a size of H×W, and object identification information may be obtained from the feature vector.

The controller 900 may attempt to obtain depth information only for the driving path surface S1 of the camera image C through the depth sensor 130. That is, the controller 900 may obtain depth information for a driving path surface S2 within a range of the performance of the depth sensor 130 from the driving path surface S1. Accordingly, the robot 1000 may recognize the driving path surface S2 within a range of the performance of the depth sensor 130 as illustrated in (4-2) of FIG. 4.

In particular, a ToF sensor may be used as the depth sensor 130, which is further described with reference to FIG. 5.

The controller 900 may attempt to obtain a point cloud of an object around the robot 1000 as shown in (5-1) of FIG. 5 through the ToF sensor 130. That is, the controller 900 may obtain a point cloud for all objects within a range of the performance of the ToF sensor 130. The controller 900 may obtain depth information for all objects through the point cloud.

Then, the controller 900 may obtain three-dimensional (3D) information about a driving path surface S4 within a range of the performance of the ToF sensor 130 based on the point cloud, as shown in (5-2) of FIG. 5.

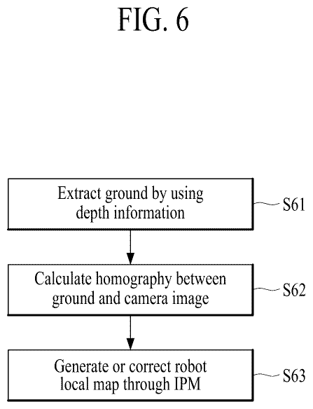

Hereinafter, with reference to FIG. 6, operations S11 to S14 of FIG. 2 will be described in more detail. FIG. 6 is a flowchart of a method of measuring a distance to an object according to an embodiment of the present disclosure.

The controller 900 may extract the ground of the driving path around the robot 1000 based on depth information about objects around the robot 1000 through the depth sensor 130 [S61]. Operation S61 may correspond to operation S11 of FIG. 2.

Then, the controller 900 may determine whether the ground of the driving path is planar, and when the ground of the driving path is planar, the controller 900 may calculate a homography between the ground and the camera image [S62]. Operation S62 may correspond to operations S12 and S13 of FIG. 2.

Determination of whether the ground of the driving path is planar and definition of a plane of the ground when the surface is planar may be performed simultaneously by the RANSAC algorithm described above. If the depth of the driving path surface may be obtained by the RANSAC algorithm as a plane equation coefficient (a, b, c) that satisfies a certain plane equation (e.g., z=ax+by+c) within a predetermined error, the driving path surface is determined to be a plane, and at the same time, the surface plane (or ground plane) of the driving path may be defined by the obtained plane equation coefficient. When the surface plane is defined, most of the sampling points (or their depths) from among sampling points on the surface of the driving path may satisfy the plane equation defining the surface plane within a given error, but unless the surface plane is a perfect plane, some sampling points may not satisfy the plane equation within a given error. The sampling points that satisfy the plane equation within a predetermined error may be defined as an inlier, and the sampling points that do not satisfy the plane equation within a predetermined error may be defined as an outlier.

Then, the controller 900 may calculate a depth of an object recognized in the camera image C on the basis of the homography.

The controller 900 may correct a local map assigned to the robot 1000 by using a depth of an object recognized in the camera image C or may newly generate a corresponding local map for the robot 1000 from the depth of the object, recognized on the ground of the driving path in the camera image C [S63]. Operation S63 may correspond to operation S14 of FIG. 2.

To elaborate further, the controller 900 may correct a 2D planar local map assigned to the robot 1000 by using an inverse perspective mapping (IPM) scheme or generate a new 2D planar local map corresponding to the ground of the driving path from the camera image.

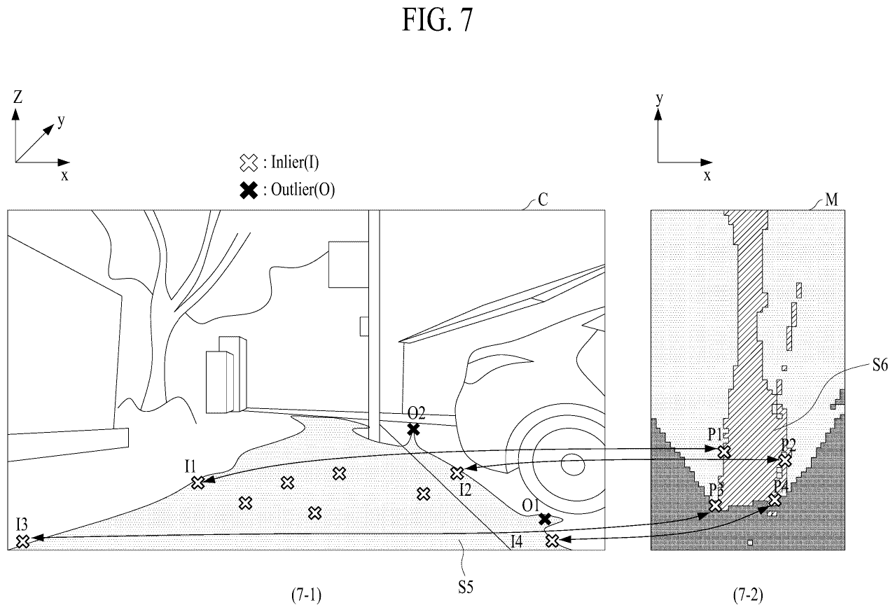

The IPM will be further described with reference to FIG. 7. FIG. 7 illustrates an example of IPM that may be used in an embodiment of the present disclosure.

(7-1) of FIG. 7 is an example of the camera image C, and (7-2) of FIG. 7 is an example of the local map M.

Although the camera image C is a 2D image, the camera image C is captured by the camera 140 of the robot 1000, and thus may be a bird eye view type image in which X, Y, and Z coordinate values are visually reflected. In contrast, the local map M may be a planar type image of X, Y coordinates.

As described above, the controller 900 may obtain a depth of each point of an object recognized in the camera image C, particularly the driving path surface, on the basis of the homography.

Therefore, the controller 900 may generate the local map M from the camera image C by causing each point of the camera image C, particularly each inlier within a first driving path surface S5, to correspond to each map point within a second driving path surface S6 of the local map M. When the local map M is generated, outliers O1 and 02 within the first driving path surface S5 may be disregarded.

Regarding the fact that a plurality of inliers within the first driving path surface S5 correspond to a plurality of map points of the local map M, first to fourth inliers I1 to 14 and first to fourth map points P1 to P4 will be described as an example.

The local map M may be generated by using a method in which points of the local map M, which correspond to a plurality of inliers within the first driving path surface S5 of the camera image C, are calculated based on the homography.

For example, based on the homography, map points of the local map M, which correspond to the first inlier I1, the second inlier I2, the third inlier I3, and the fourth inlier I4, may be calculated. That is, it may be calculated that the first inlier I1 corresponds to a first map point P1 on the basis of the homography, the second inlier I2 corresponds to a second map point P2 on the basis of the homography, the third inlier I3 corresponds to a third map point P3 on the basis of the homography, and the fourth inlier I4 corresponds to a fourth map point P4 on the basis of the homography. This may be understood as a type of perspective mapping scheme.

However, when the local map M is generated using the perspective mapping scheme, the number of sampling inliers may not be small in a region of the first driving path surface S5 of the camera image C that is relatively far from the robot, and thus there is a problem that a region of the second driving path surface S6 of the local map M that is relatively far from the robot is generated with low resolution (i.e., inaccurately).

In contrast, the local map M may be generated using a method in which points of the camera image C, which correspond to each map point of the local map M, are calculated on the basis of the homography.

For example, based on the homography, points of the camera image C, which correspond to the first map point P1, the second map point P2, the third map point P3, and the fourth map point P4, may be calculated. That is, it may be calculated that the first map point P1 corresponds to the first inlier I1 on the basis of the homography, the second map point P2 corresponds to the second inlier I2 on the basis of the homography, the third map point P3 corresponds to the third inlier I3 on the basis of the homography, and the fourth map point P4 corresponds to the fourth inlier I4 based on the homography. This may correspond to the inverse perspective mapping (IPM) scheme.

When the local map M is generated using the IPM scheme, even if the number of sampling inliers is small in a region of the first driving path surface S5 of the camera image C that is relatively far from the robot, a region of the second driving path surface S6 of the local map M that is relatively far from the robot is generated with relatively high resolution (i.e., accurately).

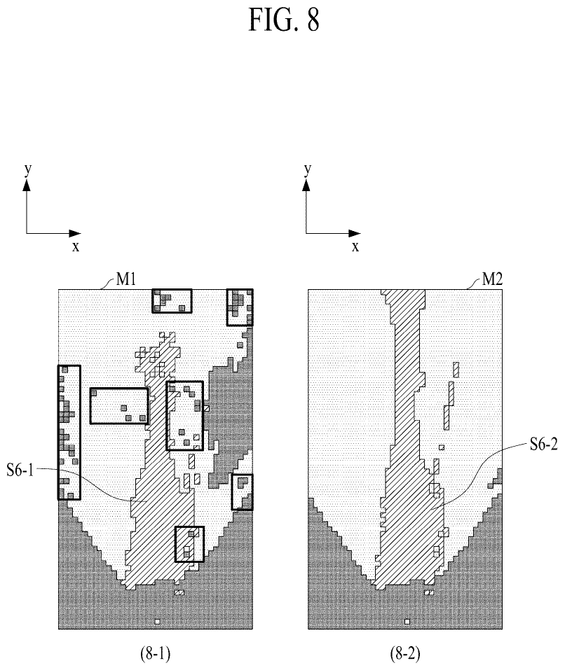

The local map generated according to the perspective mapping and the local map generated according to the IPM will be further described with reference to FIG. 8. FIG. 8 illustrates an example of a local map for a robot generated according to an embodiment of the present disclosure.

A first local map M1 illustrated in (8-1) of FIG. 8 is an example generated according to the perspective mapping described above by using the camera image C of (7-1) of FIG. 7, and a second local map M2 illustrated in (8-2) of FIG. 8 is an example generated according to the IPM described above by using the camera image C of (7-1) of FIG. 7.

When comparing the first local map M1 and the second local map M2, it may be seen that a driving path surface S6-2 of the second local map M2 is illustrated more accurately and further in the y direction than a driving path surface S6-1 of the first local map M1.

The first local map M1 may have more loss map points than the second local map M2, as indicated by square boxes. That is, the first local map MI may have a lower resolution than the second local map M2.

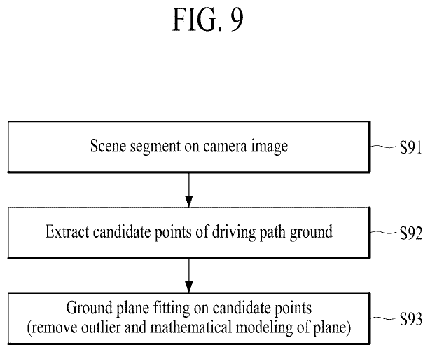

Hereinafter, with reference to FIG. 9, operation S61 of FIG. 6 will be described in more detail. FIG. 9 is a flowchart of a method of measuring a distance to an object according to an embodiment of the present disclosure.

The controller 900 may recognize a driving path surface (or ground) by performing scene segmentation on the camera image C [S91]. An example of the driving path surface of the camera image C is the same as the driving path surface S1 of (4-1) of FIG. 4 or the driving path surface S5 of (6-1) of FIG. 6. As described above, the scene segmentation may be performed using artificial intelligence technology such as computer vision technology or machine learning algorithms.

The controller 900 may extract or sample candidate points from the driving path surface [S92]. The candidate points may be, for example, extracted at equal intervals from the driving path surface. Alternatively, the candidate points may be sampled at larger intervals in a region of the driving path, which is close to the robot, and sampled at smaller intervals in a region of the driving path, which is further away from the robot.

Then, the controller 900 may fit a plane to the candidate points [S93]. An example of plane fitting may be calculation of coefficients of a plane equation that is satisfied by the candidate points within a predetermined error range. As such, a mathematical modeling of the plane may be generated while outliers of the candidate points are removed.

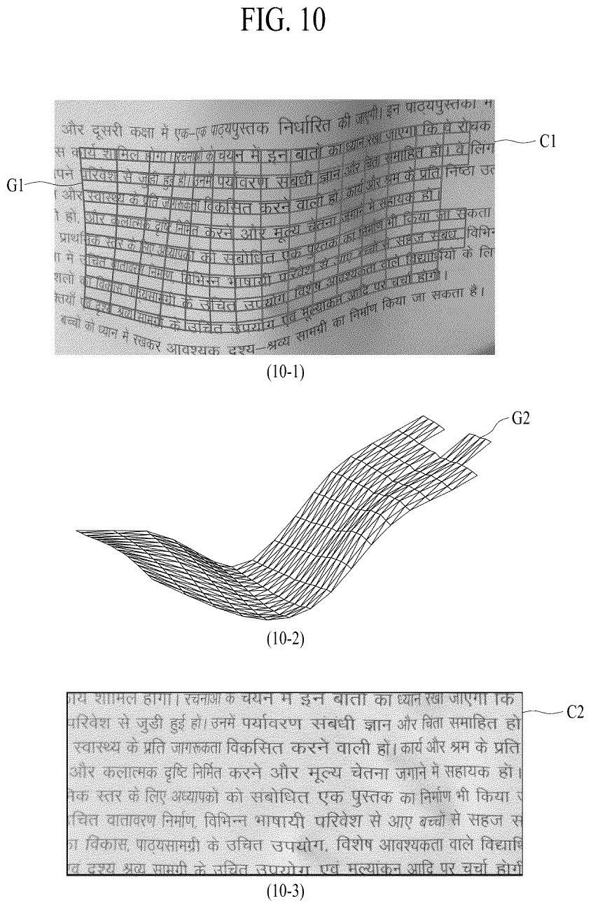

Hereinafter, operation S16 of FIG. 2 will be described with reference to FIG. 10. FIG. 10 illustrates an example of flattening of a driving path surface for a method of measuring a distance to an object, according to an embodiment of the present disclosure. In FIG. 10, for ease of explanation, flattening of a curved book page is used as an example. This may be directly applied to flattening of a driving path surface.

If the surface of the driving path is determined to be non-planar in operation S12 of FIG. 2, the controller 900 may perform a flattening process of the surface of the driving path [S16].

For the flattening process, the controller 900 may estimate 2D distortion (or warp) grid G1 by using a predetermined pattern within the camera image C1, as shown in (10-1) of FIG. 10. The predetermined pattern may be a lane in the case of the driving path surface, or a text line in the case of the book page.

Then, the controller 900 may generate a 3D reconstruction G2 on the basis of the 2D distortion grid, as shown in (10-2) of FIG. 10.

Then, the controller 900 may generate a camera image C2 obtained by flattening and distortion-correcting a driving path surface (book page) in the camera image C1 by using a method of flattening the 3D reconstruction G2, as shown in (10-3) of FIG. 10. This flattening process may be referred to as 3D reconstruction dewarping.

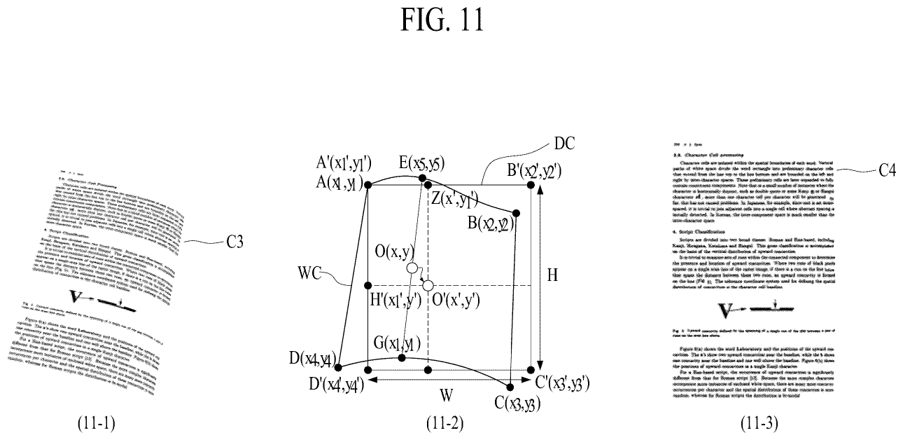

The flattening process may be performed using a method other than the 3D distortion reconstruction. This will be further explained with reference to FIG. 11. FIG. 11 illustrates an example of flattening of a driving path surface for a method of measuring a distance to an object, according to an embodiment of the present disclosure. In FIG. 11, for ease of explanation, flattening of a curved book page is used as an example. This may be directly applied to flattening of a driving path surface.

The controller 900 may obtain a warp coordinate WC as shown in (11-2) of FIG. 11 from a camera image C3 as shown in (11-1) of FIG. 11.

Then, the controller 900 may generate a dewarp coordinate DC corresponding to the warp coordinate WC as shown in (11-2) of FIG. 11 and generate a mapping equation for converting the warp coordinate WC into the dewarp coordinate DC.

Then, the controller 900 may generate a camera image C4 obtained by flattening and distortion-correcting a driving path surface (or book page) of the camera image C3, as shown in (11-3) of FIG. 11, through the mapping equation. This flattening process may be referred to as goal-oriented rectification.

Operation S13 of FIG. 2 described above may be performed on the camera image on which the driving path surface flattening process according to operation S16 has been performed.

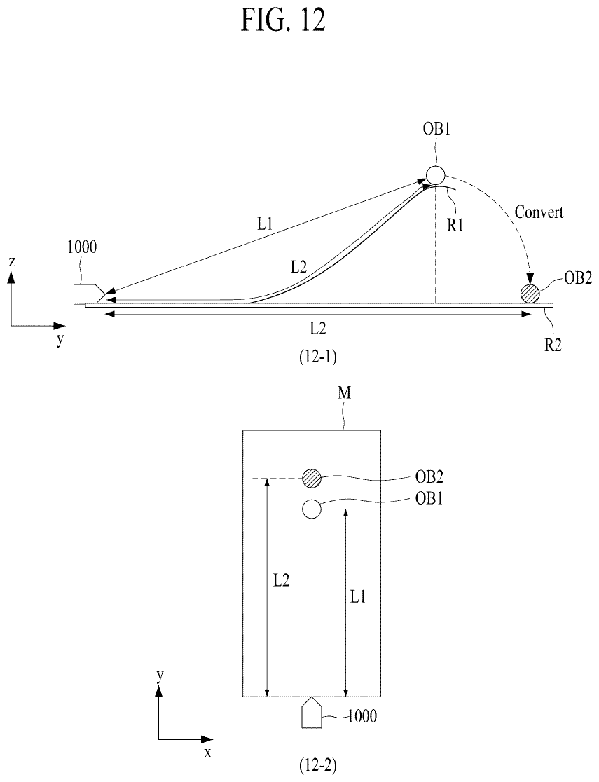

Hereinafter, with reference to FIG. 12, the necessity of flattening of the driving path surface will be explained. FIG. 12 illustrates an example of flattening of a driving path surface for a method of measuring a distance to an object, according to an embodiment of the present disclosure.

As shown in (12-1) of FIG. 12, it is assumed that an actual driving path in front of the robot 1000, i.e., a first driving path R1, is an uphill curved path and that there is an actual object, i.e., a first object OB1, on the curved path.

In this case, a straight-line distance between the robot 1000 and the first object OB1 may be a first distance L1, and a curved distance along the curved path between the robot 1000 and the first object OB1 may be a second distance L2 that is longer than the first distance L1.

The curved path R1 may be flattened into a straight path, a second driving path R2, according to the flattening process described above.

When the curved path R1 is virtually flattened to the second driving path R2, the actual object OB1 may be converted into a second object OB2 located on the second driving path R2. A virtual straight-line distance between the robot 1000 and the second object OB2 may be the second distance L2.

An actual straight-line distance between the robot 1000 and the first object OB1 is the first distance L1, but the robot 1000 needs to move the second distance L2 to reach the first object OB1. The second distance L2 may be an actual movement distance for the robot 1000 to reach the first object OB1. Therefore, in terms of driving of the robot 1000, the actual movement distance (L@) may be more important than the actual straight-line separation distance L1.

Therefore, in the local map M for the robot 1000 generated as described above, instead of displaying the first object OB1 spaced the first distance L1 from the robot 1000, as shown in (12-2) of FIG. 12, the second object OB2 spaced the second distance L2 from the robot 1000 may be displayed.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

1. A method of measuring a distance to an object by a robot, the method comprising:
obtaining a camera image;
based on a driving path ground in the camera image being to be a plane, obtaining homography between the camera image and the plane; and
calculating a depth of an object recognized in the camera image based on the obtained homography.

2. The method of claim 1, further comprising recognizing the driving path ground of the robot from the camera image.

3. The method of claim 2, wherein the recognizing of the driving path ground is performed by performing scene segmentation.

4. The method of claim 2, further comprising measuring a depth for a plurality of sampling points on the recognized driving path ground,
wherein, whether the driving path ground is planar is determined based on the measured depth.

5. The method of claim 4, whether the driving path ground is planar is determined based on a RANdom sample consensus (RANSAC) algorithm.

6. The method of claim 1, further comprising performing flattening of the driving path ground of the camera image based on that the driving path ground is determined to be non-planar.

7. The method of claim 6, further comprising generating a local map of the robot based on the depth of the driving path ground recognized as the object in the camera image.

8. The method of claim 7, wherein the local map is generated by inverse perspective mapping from the camera image.

9. The method of claim 7, wherein a virtual straight-line distance between the robot and the object according to the flattening is reflected in the local map.

10. The method of claim 7, wherein an inlier from among points on the driving path ground of the camera image corresponds to a map point of the local map, and an outlier from among points on the driving path ground is disregarded in the local map.

11. A robot comprising:
a camera configured to obtain a camera image;
a depth sensor configured to sense a depth of an object; and
a controller configured to perform control to, based on a driving path ground in the camera image being to be a plane, obtain homography between the camera image and the plane, and calculate the depth of the object recognized in the camera image based on the obtained homography.

12. The robot of claim 11, wherein the controller is configured to recognize a driving path ground of the robot from the camera image.

13. The robot of claim 12, wherein the controller is configured to recognize the driving path ground by performing scene segmentation.

14. The robot of claim 12, wherein the controller is configured to measure a depth for a plurality of sampling points on the recognized driving path ground and determine whether the driving path ground is planar based on the measured depth.

15. The robot of claim 14, whether the driving path ground is planar is determined based on a RANdom sample consensus (RANSAC) algorithm.

16. The robot of claim 11, wherein the controller is configured to perform control to perform flattening of the driving path ground of the camera image based on that the driving path ground is determined to be non-planar.

17. The robot of claim 16, wherein the controller is configured to perform control to generate a local map of the robot based on the depth of the driving path ground recognized as the object in the camera image.

18. The robot of claim 17, wherein the local map is generated by inverse perspective mapping from the camera image.

19. The robot of claim 17, wherein a virtual straight-line distance between the robot and the object according to the flattening is reflected in the local map.

20. The robot of claim 17, wherein an inlier from among points on the driving path ground of the camera image corresponds to a map point of the local map, and an outlier from among points on the driving path ground is disregarded in the local map.
